(19) United States
(12) Patent Application Publication
(10) Pub. No.: US 2024/0413297 A1
(43) Pub. Date: Dec. 12, 2024

(54) ROLLING DEVICE FOR ELECTRODE SHEET

(71) Applicants: PRIME PLANET ENERGY & SOLUTIONS, INC., Tokyo (JP); TOYOTA JIDOSHA KABUSHIKI KAISHA, Aichi-ken (JP)

(72) Inventors: Shun YAMAZAKI, Himeji-shi (JP); Masahiro SANTO, Kakogawa-shi (JP); Tetsumasa MARUO, Ibaraki-shi (JP); Kengo HAGA, Nagoya-shi (JP); Sachie AKIBA, Toyota-shi (JP)

(21) Appl. No.: 18/732,625

(22) Filed: Jun. 4, 2024

(30) Foreign Application Priority Data
Jun. 9, 2023 (JP) 2023-095148

(51) Int. Cl. H01M 4/04; B30B 3/00; B30B 3/04

(52) U.S. Cl. CPC H01M 4/0435; B30B 3/005; B30B 3/04

(57) ABSTRACT

A rolling device is a rolling device that is arranged on a conveyance path on which an electrode sheet of an electricity storage device is conveyed and includes a pair of rolling rolls. Each of the rolling rolls includes a base material, a ground layer formed at least on a rolling area of an outer peripheral surface of the base material that rolls the electrode sheet, and a diamond-like carbon (DLC) coating film formed on an outer peripheral surface of the ground layer. The ground layer is harder than the base material.

### CROSS REFERENCE OF RELATED APPLICATION

This application claims the benefit of priority to Japanese Patent Application No. 2023-095148 filed on Jun. 9, 2023. The entire contents of this application are hereby incorporated herein by reference.

### BACKGROUND OF THE DISCLOSURE

The present disclosure relates to a rolling device for electrode sheet.

For example, Japanese Laid-open Patent Publication No. 2018-190681 discloses a method for manufacturing an electrode material including a step of pressing an electrode material obtained by coating a band-like metal foil with an active material slurry layer and a ceramic slurry layer in a thickness direction. The ceramic slurry layer includes ceramic particles. In the method described in Japanese Laid-open Patent Publication No. 2018-190681, pressing is performed using a press roll having an outer peripheral surface of a roll body coated with a wear resistance layer of diamond-like carbon (DLC) as conveying the electrode material. According to Japanese Laid-open Patent Publication No. 2018-190681, direct slide contact of the roll body with the ceramic particles is eliminated by the wear resistance layer, and wear of the roll body is suppressed.

### SUMMARY

As described in Japanese Laid-open Patent Publication No. 2018-190681, by forming a DLC coating film having a high hardness on a surface of a rolling roll that rolls an electrode sheet of an electricity storage device, a wear resistance of the rolling roll can be increased. However, the DLC coating film has a low toughness, and the DLC coating film peels off from a base material of the rolling roll in some cases. When the DLC coating peels off, the base material rapidly wears. When the base material rapidly wears, there is a probability that fine particles of the base material generated by wear become contaminants and affect quality of the electrode sheet.

Therefore, herein, a rolling device for electrode sheet in which contaminants are less likely to be generated even when a DLC coating film of a rolling roll peels off is proposed.

A rolling device for electrode sheet disclosed herein is a rolling device that is arranged on a conveyance path on which an electrode sheet of an electricity storage device is conveyed and includes a pair of rolling rolls. Each of the rolling rolls includes a base material, a ground layer formed at least on a rolling area of an outer peripheral surface of the base material that rolls the electrode sheet, and a diamond-like carbon (DLC) coating film formed on an outer peripheral surface of the ground layer. The ground layer is harder than the base material.

According to the rolling device for electrode sheet, the ground layer that is harder than the base material is provided between the base material and the DLC coating film. With the ground layer, even when the DLC coating film of the rolling roll peels off, the base material does not contact the electrode sheet. Therefore, wear of the base material is prevented. Moreover, the ground layer is harder than the base material and is less likely to wear. As a result, contamination can be suppressed.

### BRIEF DESCRIPTION OF THE DRAWINGS

FIG. 1 is a schematic side view of a rolling device for electrode sheet.

FIG. 2 is a schematic plan view of the rolling device for electrode sheet.

FIG. 3 is a schematic cross-sectional view of a rolling roll.

### DETAILED DESCRIPTION OF THE PREFERRED EMBODIMENTS

Preferred embodiments of a rolling device for an electrode sheet of an electricity storage device will be described below. Note that, as a matter of course, the preferred embodiments described herein are not intended to be particularly limiting the present disclosure. The accompanying drawings are schematic and do not necessarily reflect an actual implemented product.

### [Configuration of Rolling Device]

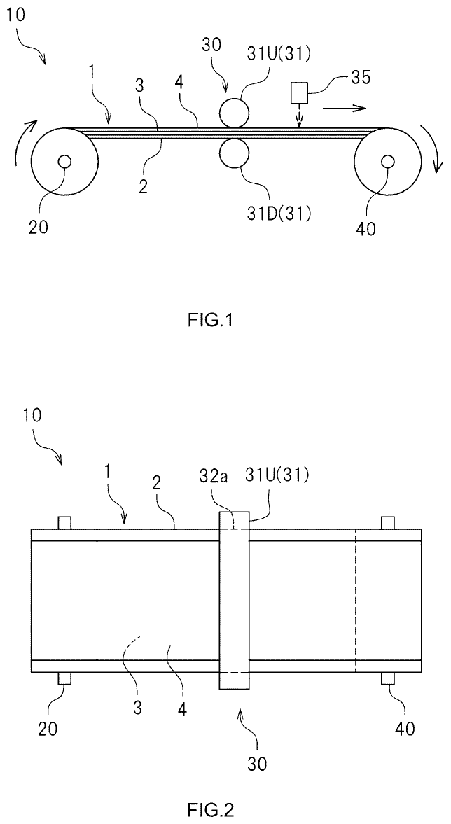

FIG. 1 is a schematic side view of a rolling device 10 for electrode sheet according to an embodiment. FIG. 2 is a schematic plan view of the rolling device 10 for electrode sheet. Herein, the rolling device 10 rolls an electrode sheet 1 of a lithium-ion secondary battery. However, the electrode sheet 1 is not limited to an electrode sheet of a lithium-ion secondary battery and may be an electrode sheet of any one of various known electricity storage devices. The term “electricity storage device” generally refers to devices from which electric energy can be taken out and encompasses so-called electricity storage batteries (chemical batteries), such as a lithium-ion secondary battery, a nickel hydrogen battery, or the like and capacitors (physical batteries), such as an electric double-layered capacitor or the like.

The electrode sheet 1 includes a band-like electrode foil 2 and an active material layer 3 formed on the electrode foil 2. A positive electrode sheet is configured such that a positive electrode active material layer 3 including a positive electrode active material is formed on a surface of a band-like electrode foil 2 (for example, aluminum foil) having a width and a thickness that are determined in advance. In a lithium-ion secondary battery, the positive electrode active material can discharge lithium ions during charging and absorb lithium ions during discharging like a lithium transition metal composite material, for example. A negative electrode sheet is configured such that a negative electrode active material layer 3 including a negative electrode active material is formed on a surface of a band-like electrode foil 2 (for example, copper foil) having a width and a thickness that are determined in advance. In a lithium-ion secondary battery, the negative electrode active material can absorb lithium ions during charging and discharge lithium ions absorbed during charging during discharging like natural graphite, for example. As to the positive electrode active material and the negative electrode active material, various other materials than the materials described above have been proposed and there is no particular limitation.

The positive electrode sheet further includes a protective layer 4 that protects the active material layer 3 and prevents reaction with an electrolyte solution. The protective layer 4 herein includes a passive state of a metal oxide (ceramic). The protective layer 4 includes, for example, an aluminum oxide (alumina). However, as to the protective layer 4, various other materials than the materials described above have been proposed and there is no particular limitation. The protective layer 4 is formed to overlap an upper layer of the positive electrode active material layer 3. In FIG. 1 and FIG. 2, as the electrode sheet 1, a positive electrode sheet including the protective layer 4 is illustrated. In the following description, it is assumed that the electrode sheet 1 includes the protective layer 4, unless specifically stated otherwise.

A raw material of the active material layer 3 is made into a slurry state and is applied to the electrode foil 2. The raw material of the active material layer 3 may be applied to one surface of the electrode foil 2 and may be applied to both surfaces thereof. For a positive electrode sheet, a material of the protective layer 4 is made into a slurry state and is applied to coat over the active material layer 3. The electrode sheet 1 is formed to include a portion on which the active material layer 3 and the protective layer 4 are applied and a non-coated portion on which neither the active material layer 3 nor the protective layer 4 is formed. The raw materials of the active material layer 3 and the protective layer 4 in a slurry state that have been applied are dried in a drying step. Thereafter, the rolling device 10 continuously presses the electrode sheet 1 as conveying the electrode sheet 1 in a longitudinal direction, to adjust each of respective thicknesses of the active material layer 3 and the protective layer 4 to a thickness in a predetermined range and densify an active material in the active material layer 3.

As illustrated in FIG. 1, the rolling device 10 is arranged on a conveyance path on which the electrode sheet 1 of the electricity storage device is conveyed. As illustrated in FIG. 1, the rolling device 10 itself may include a mechanism that conveys the electrode sheet 1. In this preferred embodiment, the rolling device 10 includes an unwinding device 20, a pressing device 30, and a winding device 40. The electrode sheet 1 with the active material layer 3 and the protective layer 4 dried thereon is supplied to the unwinding device 20 by a roll. The winding device 40 winds the electrode sheet 1 unwound from the unwinding device 20 and rolled by the pressing device 30. However, the rolling device 10 may be provided on another conveyance path of the electrode sheet 1 on which the electrode sheet 1 is conveyed by some other conveyance device.

The rolling device 10 (specifically, the pressing device 30) includes a pair of rolling rolls 31U and 31D. The rolling roll 31U at an upper side and the rolling roll 31D at a lower side face each other in an up-down direction with the conveyance path of the electrode sheet 1 interposed therebetween. The rolling roll 31U at the upper side is lowered by an unillustrated driving device when rolling the electrode sheet 1 and presses the electrode sheet 1 with the rolling roll 31D at the lower side. The thickness of the active material layer 3 and the protective layer 4 after being rolled are measured by a film thickness sensor 35. A position of the rolling roll 31U at the upper side in the up-down direction or a pressing pressure thereof is feedback controlled in accordance with the thickness of the active material layer 3 and the protective layer 4 measured by the film thickness sensor 35. Note that, in the following description, when the rolling roll 31U at the upper side and the rolling roll 31D at the lower side are not distinguished from each other, the reference symbol 31 is used to express them as the rolling rolls 31, the pair of rolling rolls 31, or the like as appropriate.

Although there is no particular limitation on a pressing force of the rolling device 10, the pressing force can reach a linear pressure of 40000 N/cm in some cases. Lengths of the rolling rolls 31U and 31D in a width direction of the electrode sheet 1 can be 100 cm in some cases. As to conveyance speed of the electrode sheet 1 during rolling, there is no particular limitation, but the conveyance speed can reach 100 m/min in some cases. The linear pressure of the rolling device 10 is high, the conveyance speed of the electrode sheet 1 is high, and the protective layer 4 is hard, so that a large friction force is applied to the pair of rolling rolls 31U and 31D. A Vickers' hardness of a ceramic portion of the protective layer 4 is, for example, 1400 HV to 1800 HV. As the conveyance speed of the electrode sheet 1 is high, a wear amount of the rolling rolls 31 per unit hour is increased.

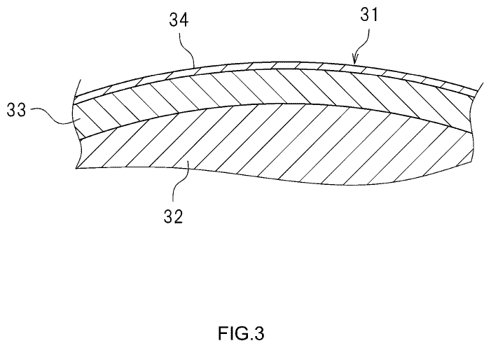

FIG. 3 is a schematic cross-sectional view of the rolling roll 31. As illustrated in FIG. 3, the rolling roll 31 includes a base material 32, a ground layer 33, and a diamond-like carbon (DLC) coating film 34. The base material 32 is a base body of the rolling roll 31 formed into a cylindrical shape. The base material 32 is formed of, for example, a high carbon content bearing steel material (SUJ material), and is preferably formed of, for example, SUJ2 having high versatility. However, a material of the base material 32 is not limited to the SUJ material. The base material 32 may be formed of, for example, chrome steel, chromium molybdenum steel, stainless steel, or the like. As a material of the base material 32, a material having a strength to bear the pressing pressure of the rolling roll 31 and being excellent in terms in availability, workability, cost, or the like is preferable. In this preferred embodiment, a hardness of the base material 32 does not need to be very high. A Vickers' hardness of a preferable material as the base material 32 is, for example, 600 HV or more and 900 HV or less.

The ground layer 33 is a layer harder than the base material 32 and is formed on a surface of the base material 32. The ground layer 33 is formed at least on a rolling area 32a (see FIG. 2) of an outer peripheral surface of the base material 32 that rolls the electrode sheet 1. As illustrated in FIG. 2, the rolling area 32a is an area that contacts the electrode sheet 1 during rolling. A width of the rolling area 32a in a width direction of the electrode sheet 1 is equal to a width of the electrode sheet 1. The ground layer 33 may be formed on a portion of the outer peripheral surface of the base material 32 that includes the rolling area 32a and is broader than the rolling area 32a. For example, the ground layer 33 may be formed on the entire outer peripheral surface of the base material 32.

In this preferred embodiment, the ground layer 33 is formed of cemented carbide. More specifically, the ground layer 33 is formed of a thermal-sprayed film of cemented carbide. The cemented carbide is a material obtained by sintering tungsten carbide with metal, such as cobalt, nickel, or the like. In the cemented carbide, the metal that bonds fine particles of tungsten carbide is not limited to cobalt or nickel. The thermal-sprayed film is a coating film formed by spraying a material in a molten state or a state close to a molten state to a base material. The thermal-sprayed film of the cemented carbide is formed, for example, by a high-speed flame spraying method. However, the ground layer 33 may be a thermal-sprayed film of some other material than cemented carbide, for example, a material (so-called cermet) including a metal oxide (ceramic) and metal. As another option, the ground layer 33 may be formed by some other method than thermal spraying. For example, the ground layer 33 may be formed of hard chrome plating.

The ground layer 33 is formed of a material harder than at least the base material 32. A Vickers' hardness of the ground layer 33 is preferably 900 HV or more. The Vickers' hardness of the ground layer 33 is more preferably 1200 HV or more. A Vickers' hardness of cemented carbide is about 1100 HV to 1500 HV. A Vickers' hardness of hard chrome plating is about 750 HV to 1000 HV.

The ground layer 33 is preferably formed thick. As a method for forming the ground layer 33 to a large thickness, thermal spraying is suitable. The ground layer 33 is preferably formed to have an average thickness of 50 μm or more. More preferably, the ground layer 33 is formed to have an average thickness of 100 μm or more.

As illustrated in FIG. 3, the DLC coating film 34 is formed on an outer peripheral surface of the ground layer 33. The DLC coating film 34 is a carbon coating film having a carbon bond structure of both of diamond and graphite. The DLC coating film 34 is formed, for example, by plasma chemical vapor deposition (CVD) method in which hydrogen carbonate gas is converted into plasma and is vapor deposited or sputtering using graphite as a raw material. A Vickers' hardness of the DLC coating film 34 is, for example, 1600 HV or more and 2500 HV or less. The Vickers' hardness of the DLC coating film 34 is larger than the Vickers' hardness of the ground layer 33. An average thickness of the DLC coating film 34 is, for example, 2 μm to 3 μm. A realizable thickness of the DLC coating film 34 is several μm or less. An average thickness of the ground layer 33 is larger than the average thickness of the DLC coating film 34. The average thickness of the ground layer 33 is preferably ten times the average thickness of the DLC coating film 34 or more.

### Effects of Preferred Embodiment

Effects that can be achieved by the rolling device 10 for the electrode sheet 1 according to this preferred embodiment will be described below.

The rolling device 10 for the electrode sheet 1 according to this preferred embodiment is arranged on the conveyance path on which the electrode sheet 1 of the electricity storage device is conveyed and incudes the pair of rolling rolls 31. Each of the rolling rolls 31 includes the base material 32, the ground layer 33 formed at least on the rolling area 32a of the outer peripheral surface of the base material 32 that rolls the electrode sheet 1, and the DLC coating film 34 formed on the outer peripheral surface of the ground layer 33. The ground layer 33 is harder than the base material 32.

The DLC coating film 34 has a low toughness and can peel off from the base material 32 in some cases. For example, when the rolling rolls 31 bite a foreign matter or the like, the DLC coating film 34 tends to peel off. According to a known technology, each of rolling rolls that roll electrode sheet 1 of the electricity storage device is configured such that a DLC coating film is formed on an outer peripheral surface of a base material. Therefore, in the known rolling rolls, when the DLC coating film peels off, the base material rapidly wears. The electrode sheet 1, specifically, the protective layer 4 is very hard, the pressing pressure is large, and the conveyance speed of the electrode sheet 1 is high, and therefore, the base material rapidly wears. When the base material rapidly wears, there is a probability that fine particles of the base material generated by wear become contaminants and affect quality of the electrode sheet 1.

In contrast, in the rolling device 10 according to this preferred embodiment, the ground layer 33 that is harder than the base material 32 is provided between the base material 32 and the DLC coating film 34. Even when the DLC coating film 34 of the rolling rolls 31 peels off, with the ground layer 33 provided, the base material 32 does not contact the electrode sheet 1. Therefore, wear of the base material 32 is prevented. Moreover, the ground layer 33 is harder than the base material 32 and is less likely to wear. As a result, contamination can be suppressed.

In the known rolling rolls, when the DLC coating film wears off through long-term use and a portion or an entire portion of the DLC coating film is eliminated, the base material rapidly wears. Therefore, during a period from when the DLC coating film has worn and peeled off to when wear or peeling off of the DLC coating film is found and the rolling rolls are changed, the wear of the base material progresses. Thus, a life of the rolling rolls is shortened. While the base material can be used, the DLC coating film is re-formed on the base material for reuse.

In contrast, in the rolling device 10 according to this preferred embodiment, it is the ground layer 33 that, after the DLC coating film 34 wears or peels off, contacts the electrode sheet 1 and wears. The ground layer 33 is harder than the base material 32, and a wear amount thereof is smaller than that of the base material 32. Therefore, the rolling rolls 31 can be maintained in a reusable state for a long period of time, and the DLC coating film 34 can be re-formed more times than that in the known technology. As a result, the life of the rolling rolls 31 can be extended longer than that in the known technology.

In this preferred embodiment, the ground layer 33 is formed of cemented carbide. According to the configuration described above, the hardness of the ground layer 33 formed of cemented carbide is high, and therefore, the wear amount of the rolling rolls 31 can be further reduced.

In this preferred embodiment, the average thickness of the ground layer 33 is larger than the average thickness of the DLC coating film 34. According to the configuration described above, the ground layer 33 has a large thickness, and therefore, the life of the rolling rolls 31 can be further extended.

In this preferred embodiment, the average thickness of the ground layer 33 is 50 μm or more. According to the configuration described above, the ground layer 33 has a large thickness, and therefore, the life of the rolling rolls 31 can be further extended. According to a trial product manufactured by the inventors of the present application, the life of the rolling rolls 31 configured such that the average thickness of the ground layer 33 is 50 μm or more is several times that of the known rolling rolls (the material of the base material is SUJ2) in which the DLC coating film is formed on a surface of the base material or more.

In this preferred embodiment, the ground layer 33 is formed of a thermal-sprayed film. According to the configuration described above, a high degree of freedom for the material of the ground layer 33 is achieved. Thermal spraying has fewer restrictions on materials that can be used for forming a film. Moreover, the ground layer 33 can be easily formed to a large thickness by thermal spraying.

### Other Preferred Embodiments

One preferred embodiment of the rolling device for the electrode sheet proposed herein has been described above. However, the preferred embodiment described above is merely an example, and a rolling device for an electrode sheet according to the present disclosure can be implemented in various other embodiments. For example, in the preferred embodiment described above, each of the rolling rolls 31 has a three-layered structure of the base material 32, the ground layer 33, and the DLC coating film 34, but not limited thereto. The rolling roll may have a multilayer structure including four or more layers in which a base material is arranged in an innermost side in a radial direction, a DLC coating film is arranged in an outermost side in the radial direction, and a ground layer is arranged between the base material and the DLC coating film.

Furthermore, the preferred embodiment described above shall not limit the present disclosure, unless specifically stated otherwise. Various changes can be made to a technology described herein, and each of components and processes described herein can be omitted as appropriate or can be combined as appropriate, unless a particular problem occurs.

The present specification includes disclosure set force in the following items.

Item 1: A rolling device for electrode sheet that is arranged on a conveyance path on which an electrode sheet of an electricity storage device is conveyed, the rolling device comprising:
a pair of rolling rolls,
wherein
each of the rolling rolls includes
   a base material,
   a ground layer formed at least on a rolling area of an outer peripheral surface of the base material that rolls the electrode sheet, and
   a diamond-like carbon (DLC) coating film formed on an outer peripheral surface of the ground layer, and
the ground layer is harder than the base material.

Item 2: The rolling device for electrode sheet according to Item 1, wherein
the ground layer is formed of cemented carbide.

Item 3: The rolling device for electrode sheet according to Item 1 or 2, wherein
an average thickness of the ground layer is larger than an average thickness of the DLC coating film.

Item 4: The rolling device for electrode sheet according to any one of Items 1 to 3, wherein
the average thickness of the ground layer is 50 μm or more.

Item 5: The rolling device for electrode sheet according to any one of Items 1 to 4, wherein
the ground layer is formed of a thermal-sprayed film.

What is claimed is:

1. A rolling device for electrode sheet that is arranged on a conveyance path on which an electrode sheet of an electricity storage device is conveyed, the rolling device comprising:
a pair of rolling rolls,
wherein
each of the rolling rolls includes
a base material,
a ground layer formed at least on a rolling area of an outer peripheral surface of the base material that rolls the electrode sheet, and
a diamond-like carbon (DLC) coating film formed on an outer peripheral surface of the ground layer, and
the ground layer is harder than the base material.

2. The rolling device for electrode sheet according to claim 1, wherein
the ground layer is formed of cemented carbide.

3. The rolling device for electrode sheet according to claim 1, wherein
an average thickness of the ground layer is larger than an average thickness of the DLC coating film.

4. The rolling device for electrode sheet according to claim 1, wherein
the average thickness of the ground layer is 50 μm or more.

5. The rolling device for electrode sheet according to claim 1, wherein
the ground layer is formed of a thermal-sprayed film.
